(19) United States
(12) Patent Application Publication
(10) Pub. No.: US 2005/0026042 A1
(43) Pub. Date: Feb. 3, 2005

(54) Polyimide-based battery for a portable electronic appliance

(76) Inventors: Alain Vallee, Varennes (CA); Fabrice Regisser, Varennes (CA)

Correspondence Address: SMART & BIGGAR;Suite 3400, 1000 de la Gauchetiere Street West, Montreal, QC, H3B 4W5, CA

(21) Appl. No.: 10/628,403

(22) Filed: Jul. 29, 2003

(51) Int. Cl. H01M 10/40; H01M 10/04; H01M 4/62; H01M 4/50; H01M 2/16; H01M 4/52; H01M 4/48

(52) U.S. Cl. 429/314; 429/309; 429/231.3; 429/231.1; 429/231.5; 429/231.2; 429/224; 429/223; 429/217; 29/623.1; 429/254

(57) ABSTRACT

A battery for a Portable Electronic Appliance (PEA) that has an anode, a cathode and an electrolyte spacer between the anode and the cathode. The electrolyte spacer includes a polyamide and solvent present in a range from about 10% to about 40% by weight of the electrolyte spacer.

### FIELD OF THE INVENTION

The present invention relates to batteries. In particular, it is related to lithium batteries containing a polyimide-based electrolyte for use in portable electronic appliances.

### BACKGROUND OF THE INVENTION

Lithium polymer batteries are particularly well suited for Portable Electronic Appliances (PEA) that a user is likely to carry in a purse or pocket. Examples of portable electronic appliances include a cell phone, a Personal Digital Assistant (PDA), a laptop computer, a smart card, a camcorder and digital camera, among others. For those applications, size, weight and battery performance are critical.

Lithium polymer batteries that use a polyimide-based electrolyte are a class of batteries that are considered promising candidates for PEA applications. The U.S. Pat. No. 5,888,672 to Gustafson et al., issued on Mar. 30^{th}, 1999 discloses such a battery construction. Gustafson proposes essentially a dry cell where all the solvent used during the manufacturing process to prepare various slurries from which the individual layers of the battery are made, is dried, such that the final product contains virtually no solvent. The downside of this arrangement resides in a poor ionic conductivity, which reduces the discharge capacity of the battery.

The U.S. Pat. No. 6,451,480 to Gustafson et al. issued on Sep. 17^{th}, 2002 discloses a battery construction that also uses polyimide but instead of relaying on a dry electrolyte, employs a liquid electrolyte. The liquid electrolyte is made by dissolving lithium salt in an organic binder. The problem of this form of battery construction is two fold. First, batteries containing a liquid substance are not desirable for PEA applications. If the battery is punctured, the liquid electrolyte can leak out or spill, staining the clothes of the wearer and even creating a health hazard as a result of accidental ingestion or contact with bare skin. Second, the presence of liquid solvent, which is a flammable substance, creates a small but never the less real risk of battery explosion. An explosion may occur if the liquid electrolyte thermally runs away leading to pressure build up in the battery that can rupture the battery container. The resulting leak of solvent vapors may be ignited by an external spark. While such risk may be acceptable for industrial applications where the battery is enclosed in a protective casing and remains most of the time at a safe distance from people, the same degree of risk cannot be tolerated for PEA applications where the battery is in close proximity to the body of the user.

Against this background there is a clear need in the industry to provide an improved battery using polyimide-based electrolyte, specifically for PEA applications, that overcomes at least some of the drawbacks discussed above.

### SUMMARY OF THE INVENTION

According to a first broad aspect the invention provides a battery for a PEA that has an anode, a cathode and an electrolyte spacer between the anode and the cathode. The electrolyte spacer includes a polyamide and solvent present in a range from about 10% to about 40% by weight of the electrolyte spacer.

By providing solvent in the electrolyte the ionic conductivity of the electrolyte is increased which improves its discharge capacity. At the same time, by limiting the amount of solvent to the range specified above, the risk of battery explosion is significantly reduced and the risk of electrolyte leakage outside the battery is practically eliminated since the electrolyte is a virtually solid substance at such solvent levels. Consequently, the battery according to the invention is particularly well suited for PEA applications, by offering a good balance between battery performance and low risk of explosion and electrolyte spill. According to a second broad aspect, the invention provides a process for manufacturing a battery for use in a PEA. The method comprises:
a) preparing an electrolyte separator including polyamide and solvent present in a range from about 10% to about 40% by weight of the electrolyte;
b) using the electrolyte separator to assemble a cell in which the electrolyte separator is located between a cathode and an anode. Optionally, the method includes the step of charging the battery.

### BRIEF DESCRIPTION OF THE DRAWINGS

A detailed description of examples of implementation of the present invention is provided hereinbelow with reference to the following drawings, in which:

FIG. 1 is a schematic cross-sectional view of an example of implementation of a PEA battery in accordance with a non-limiting example of implementation of the present invention;

FIG. 2 is a graph illustrating the relationship between the discharge capacity of a polyimide-based electrochemical cell and the solvent content of the polyimide-based electrolyte; and,

FIG. 3 is a schematic cross-sectional view of a bi-face configured electrochemical cell according to another non-limiting example of implementation of the present invention.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

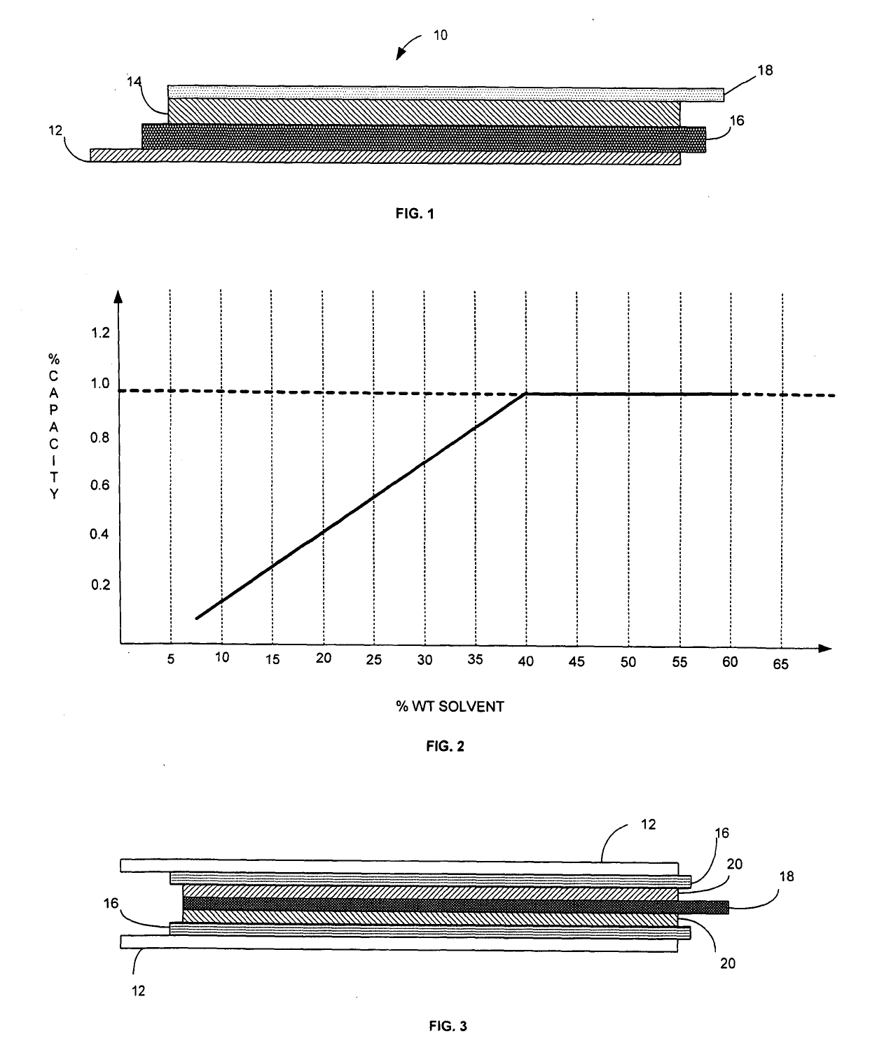

FIG. 1 is a schematic cross-sectional view of a battery 10 according to one example of implementation of the present invention. In particular, the battery 10 is specifically designed for PEA use and comprises at least one anode 12, at least one cathode 14 and an electrolyte separator 16 disposed between the anode 12 and the cathode 14. The anode 12 may be any type of anode known to those skilled in the art but is preferably a composite anode containing a host insertion material such as carbon or graphite capable of intercalating lithium ions and supported by a metal current collector preferably a copper foil or grid.

The cathode is a mixture of an active material such as a transitional metal oxide, an electronic conductive filler such as carbon black or metal particles and an ionically conductive electrolyte polymer binder comprising a lithium salt. The electrolyte polymer binder may be an electrolyte polyimide binder comprising an alkali metal salt or a polyether binder also comprising an alkali metal salt. A metal current collector 18 made of thin aluminum foil supports the cathode 14.

In general, the active material of the cathode may be selected from cobalt oxide, nickel oxide, nickel cobalt oxide, nickel cobalt aluminum oxide, manganese oxide (LiMn₂O₄) or their analogs for so-called 4 V cathodes or among cathodes of less hand 4 V such as phosphates or other polyanions of transition metals such as LiFePO₄, Nasicon structures also including V₂O₅, LiV₃O₈ and MnO₂. The reader will appreciate that many different types of active material can be used without departing from the spirit of the invention.

The electrolyte separator 16, as the name implies acts as a physical spacer to prevent direct contact between the anode 12 and the cathode 14, while providing an ionic transport vehicle therebetween. In a specific example of implementation, the electrolyte separator includes soluble polyimide, at least one alkali metal salt preferably a lithium salt.

The alkali metal salt(s) may be for example salts based on lithium trifluorosulfonimide described in U.S. Pat. No. 4,505,997, LiPF₆, LiBF₄, LiSO₃CF₃, LiClO₄, and LiSCN, etc. Different alkali metal salts can be used without departing form the spirit of the invention.

The soluble polyimide may be any soluble polyimide known to those skilled in the art. Specific examples include but are not limited to: MATRIMID XU5218 commercially available from Ciba-Geigy; ULTEM 1000P commercially available from General Electric; LaRC—CP1, LaRC—CP2, and LaRC—Si available from Imitec, Inc., Schenectady, N.Y. The soluble polyimides used in the present invention are fully imidized and are usually in powder form.

The electrolyte separator 16 also includes solvent in the range from about 10% to about 40% by weight of the electrolyte separator 16. The choice of solvent and the percentage by weight of solvent used in the electrolyte separator should be made in accordance with the specific construction of the battery and its intended application. For instance, application requiring high current discharge may require a battery having more solvent content than a battery for application requiring low current discharge. The solvent should be able to enhance the ionic mobility and at the same time should not adversely affect the structure or the operation of various battery components or materials. Many types of solvents can fulfill the above objectives. It is within the reach of a person skilled in the art to select the proper solvent that will achieve the desired level of ionic mobility while remaining compatible with the components or materials of the specific battery construction being considered. The following are examples of solvents able to solubilize polyimide powder that will enhance the ionic mobility: N,N-methylpyrolidinone (NMP), Gamma-butyrolactone, and sulfamides of formula; R1R2N—SO2—NR3R4, in which R1, R2, R3 and R4 are alkyls having between 1 and 6 carbon atoms and/or oxyalkyls having between 1 and 6 carbon atoms or combinations thereof. Advantageously, the solvent is polar and aprotic.

FIG. 2 illustrates the relationship between discharge capacity, which is directly related to ionic conductivity, and the polyimide based electrolyte's solvent content in percentage by weight. A discharge capacity of interest for PEA applications is within the range between about 10% by weight to about 40% by weight of solvent. In this range, the polyimide based electrolyte has good ionic conductivity at 25° C. and at the same time the amount of solvent is limited which greatly reduces the risks of catastrophic failures due to thermal runaway. The relation between discharge capacity and percentage by weight of solvent in the electrolyte is almost linear however the polyimide based electrolyte assumes more solid mechanical properties at levels of solvent content below 40% by weight. At 20% to 40% by weight of solvent, the polyimide based electrolyte exhibits excellent ionic conductivity yet its matrix is firm and compact limiting the dangers of spillage or catastrophic failures. In light of this relation, the solvent content in the polyimide electrolyte may be selected as a function of the specific PEA application of the polyimide-based battery. For example, for applications requiring a low discharge current (low C-rate), the polyimide electrolyte of the battery may contain less solvent than for applications requiring higher discharge current (high C-rate).

An example of implementation of a battery according to the present invention will now be described in conjunction with the process for making a battery having a bi-face configuration. It will be plain to the reader that the scope of the present invention is not limited to any particular battery configuration.

As a first step, the cathode 14 of the battery is prepared. As shown at FIG. 3, the cathode 14 is a layered structure having two cathode layers 20 coated or otherwise attached on both sides of a thin aluminum current collector 18. Each cathode layer 20 comprises an electrochemically active material such as a transitional metal oxide (LiCoO₂; LiMnO₂; LiNiO₂; Li₄Ti₅O₁₂; LiV₃O₈; V₆O₁₃; V₂O₅; and LiMn₂O₄ and their equivalents); electronic conductive filler such as conductive carbon, carbon black, graphite, graphite fiber and metallic particles; and an ionically conductive electrolyte polymer binder. The ionically conductive electrolyte polymer binder preferably comprises a lithium salt and comprises either a polyether based mono, ter or co-polymer or a pre-imidized soluble polyimide powder. The lithium salt and the polymer are soluble in polar solvent. The method for manufacturing the material from which the two layers 20 of the cathode are made includes selecting the specific constituents and their respective compositions and making a slurry by dissolving the constituents in solvent. The slurry is then layered in sheet form and dried to fully or partially eliminate the solvent.

The second step of the process is the preparation of the electrolyte separator 16. In a specific example of implementation, the electrolyte separator 16 comprises from about 30% by weight to about 70% by weight of the soluble polyimide, from about 5% by weight to about 20% by weight of the lithium salt and from about 10% by weight to about 40% by weight of solvent. In a more specific embodiment, the electrolyte comprises from about 15% to about 35% by weight of solvent. In a further specific embodiment, the electrolyte comprises from about 15% to about 30% by weight of solvent. In a further specific embodiment, the electrolyte comprises from about 20% to about 25% by weight of the electrolyte separator 16.

The preparation of the electrolyte separator 16 starts by selecting the specific components that will be used and their respective concentrations. Once this stage is completed, the polyimide powder is first dissolved in a solvent such as N,N-methylpyrolidinone (NMP), Gamma-butyrolactone, and sulfamides of formula; R1R2N—SO₂—NR3R4, in which R1, R2, R3 and R4 are alkyls having between 1 and 6 carbon atoms and/or oxyalkyls having between 1 and 6 carbon atoms or combinations thereof. Advantageously, the solvent is polar and aprotic in order to form a polyimide solution. The lithium salt is then dissolved in the polyimide solution. The polyimide solution is then partially dried at a temperature suitable to evaporate excess solvent in order to obtain a polyimide solution containing between 10% and 40% by weight of solvent and form the polyimide based electrolyte separator 16. The percentage by weight of solvent is calculated as the weight of solvent divided by the total weight of electrolyte, which in this example includes polyimide, alkali metal salt and solvent.

The third step of the process is the assembly of the battery. A lithium metal anode 12, the electrolyte separator 16, and the cathode 14 are assembled to form a cell stack. The electrolyte separator 16 is positioned between the anode 12 and the cathode 14 to prevent a short-circuit in the cell. The cell may have a monoface or bi-face configuration and may be stacked in prismatic, folded, wound, cylindrical, or jelly rolled configuration as is well known to those skilled in the art. Once the cell stack is formed, pressure is preferably applied to the cell stack to improve interlayer conductivity. The cell stack is then placed in a suitable container designed to maintain the pressure on the various layers. Various types of containers can be used to hold the cell stack. Advantageously, the container is sealed to prevent escape of any solvent vapors.

In a possible variant, the electrolyte separator is formed directly on the cathode 14. The polyimide powder and a lithium salt are first dissolved in the solvent to form a polyimide solution. The polyimide solution is then coated onto each cathode layer 14 and dried at a temperature suitable to evaporate excess solvent in order to obtain a polyimide solution containing between 10% and 40% by weight of solvent to form the electrolyte separator. As previously mentioned, the solvent or combination of solvents are selected from the group consisting of N,N-methylpyrolidinone (NMP), Gamma-butyrolactone, and sulfamides of formula; R1R2N—SO₂—NR3R4, in which R1, R2, R3 and R4 are alkyls having between 1 and 6 carbon atoms and/or oxyalkyls having between 1 and 6 carbon atoms.

In another possible variant, the cathode layer 14 and the polyimide based electrolyte separator 16 may also be coated or otherwise applied onto polypropylene support films separately and then laminated together as is well known in the art.

In another possible variant, a separator film may be integrated in the electrolyte separator to further enhance its physical barrier properties. The separator film is a discrete film made of an organic polymer, such as polypropylene. Examples of such films include but are not limited to Kynar FLEX from Atochem North America; and CELGARD 3401 from Polyplastics Co., Ltd. The separator film is either partially soaked with a polyimide solution, prepared as described earlier, with a solvent content within the selected range or the separator film is saturated with a polyimide solution having excess solvent which is then partially dried to obtain the desired percentage by weight of solvent.

The manufacture of the battery is completed after the cell is placed in the package, as described earlier. At this point the battery can be charged to store an electric charge and it is then ready for use in a PEA. Typically, batteries for use in a PEA have a weight that will not exceed 500 g. For small PEAs, such as cell phones, digital cameras or PDAs, the weight of the battery will typically be less than 250 g.

Although various embodiments have been illustrated, this was for the purpose of describing, but not limiting, the invention. Various modifications will become apparent to those skilled in the art and are within the scope of this invention, which is defined more particularly by the attached claims.

1) A battery for a PEA, comprising:
a) an anode;
b) a cathode;
c) an electrolyte separator between said anode and said cathode, said electrolyte separator including polyimide and solvent present in a range from about 10% to about 40% by weight of said electrolyte.

2) A battery as defined in claim 1, wherein the portable electronic appliance is selected in the group consisting of cell phone, PDA, laptop computer, smart card, camcorder and digital camera.

3) A battery as defined in claim 2, wherein said electrolyte separator includes solvent in the range from about 15% to about 30% by weight of said electrolyte.

4) A battery as defined in claim 3, wherein said electrolyte separator includes solvent in the range from about 20% to about 25% by weight of said electrolyte.

5) A battery as defined in claim 2, wherein said battery has a weight less than 500 grams.

6) A battery as defined in claim 5, wherein said battery has a weight less than 250 grams.

7) A battery as defined in claim 2, wherein said anode contains material capable of intercalating lithium ions.

8) A battery as defined in claim 7, wherein said anode includes a current collector.

9) A battery as defined in claim 2, wherein said solvent is selected from the group consisting of N,N-methylpyrolidinone (NMP), gamma-butyrolactone, sulfamides of formula R₁R₂N—SO₂—NR₃R₄, in which R₁, R₂, R₃ and R₄ are alkyls having between 1 and 6 carbon atoms and/or oxyalkyls having between 1 and 6 carbon atoms, and combinations thereof.

10) A battery as defined in claim 2, wherein said cathode includes active material.

11) A battery as defined in claim 10, wherein said active material is selected from the group consisting of LiCoO₂; LiMnO₂; LiNiO₂; Li₄Ti₅O₁₂; LiV₃O₈; V₆O₁₃; V₂O₅; and LiMn₂O₄ and combinations thereof.

12) A battery as defined in claim 10, wherein said cathode includes an electronic conductive filler.

13) A battery as defined in claim 12, wherein said cathode includes an ionically conductive electrolyte polymer binder.

14) A battery as defined in claim 2, wherein said electrolyte separator comprises an alkali metal salt.

15) A battery as defined in claim 14, wherein said alkali metal salt is selected from the group consisting of LiPF₆, LiBF₄, LiSO₃CF₃, LiClO₄, LiSCN and combinations thereof.

16) A method for manufacturing a battery for a PEA, comprising:
a) preparing an electrolyte separator including polyimide and solvent present in a range from about 10% to about 40% by weight of said electrolyte;
b) using said electrolyte separator to assemble a cell in which said electrolyte separator is located between a cathode and an anode.

17) A method as defined in claim 16, comprising charging said battery.
